(19) United States
(12) Patent Application Publication
(10) Pub. No.: US 2010/0073424 A1
(43) Pub. Date: Mar. 25, 2010

(54) APPARATUS AND METHODS FOR FULL-WIDTH WIDE FORMAT INKJET PRINTING

(75) Inventors: Michael D. MILLS, Moultonboro, NH (US); Paul Alan DUNCANSON, Franklin, NH (US)

Correspondence Address: GLENN PATENT GROUP, 3475 EDISON WAY, SUITE L, MENLO PARK, CA, 94025, US

(73) Assignee: ELECTRONICS FOR IMAGING, INC., Foster City, CA (US)

(21) Appl. No.: 12/628,853

(22) Filed: Dec. 1, 2009

Related U.S. Application Data
(62) Division of application No. 11/425,867, filed on Jun. 22, 2006.

(51) Int. Cl. B41J 23/00

(52) U.S. Cl. 347/37

(57) ABSTRACT

Apparatus and methods are provided for wide format inkjet printing using conventional piezoelectric inkjet print heads that each print at a native resolution. A plurality of inkjet print heads are disposed in a print head array to print an image on the substrate at the native resolution across an entire width of the substrate without scanning across the width of the substrate. The print head array may be shifted in a direction parallel to the width of the substrate, and the print head array may be used to print images on the substrate in multiple passes to form a composite image having a resolution equal to a multiple of the native resolution. Alternatively, a plurality of print head arrays may be provided, with adjacent print head arrays spaced apart to provide a composite print resolution equal to a multiple of the native resolution.

### BACKGROUND

Wide format printing systems are adapted for printing images on large scale print media, such as for museum displays, billboards, sails, bus boards, banners, point of purchase displays and other similar print media. Some wide format print systems use drop on demand ink jet printing. In such systems, a piezoelectric vibrator applies pressure to an ink reservoir of a print head to force ink through nozzles positioned on the underside of the print head. A conventional wide format inkjet printer includes a print carriage that has a set of print heads arranged in a row along a single axis. As the carriage scans back and forth along the direction of the print head axis, the print heads deposit ink drops across the width of the substrate. An image is created by controlling the order at which the ink drops are ejected from the various inkjet nozzles.

In recent years, demand has grown for wide format printers that print at very high resolution (e.g., 600 dots per inch and higher). The print resolution of a conventional scanning wide format printer may be controlled by altering the lay-down method (or interlacing) of the dots being applied to the media by the print head carriage. That is, to achieve higher resolution, the carriage may pass over a particular area more times to allow the print heads to deposit more ink dots per unit length. Thus, increases in the print resolution of a conventional wide format printer have typically come at the expense of print speed.

An alternative wide format inkjet printer includes an array of inkjet print heads arranged along a single axis in a row that spans the entire width of the print media. Because such printers eliminate the need to scan a carriage across the width of the print media, such “full width” inkjet printers potentially could achieve high resolution without sacrificing print speed. However, conventional full width inkjet printers have gaps between adjacent print heads. Thus, although each print head may print at a specific resolution (referred to as the “native resolution”), as result of the intra-print head gaps, the media must be moved under the print heads additional times to fill in the print area associated with these gaps.

One technique to solve this problem would be to design a custom inkjet print head that spans the entire width of the print media, and that has a continuous resolution across the entire width of the print media. The problem with such a solution is that it is extremely costly to develop and manufacture such a custom inkjet print head, which would not benefit from the economies of scale that may be achieved by conventional inkjet print heads that are manufactured in high volume.

Another previously known full width wide format printer uses arrays of silicon ink chips that span the entire width of the print media. Although such printers achieve a continuous resolution across the entire width of the print media, ink chips are much more fragile than conventional piezoelectric print heads. As a result, such full width ink chip printers are more costly and less reliable than conventional inkjet printers, and suffer from frequent down time for repairs.

In view of the foregoing, it would be desirable to provide full width, wide format inkjet printers that use conventional piezoelectric inkjet print head technology, and that provide a continuous resolution across the entire width of print media. It further would be desirable to provide full width, wide format inkjet printers that provide high resolution at high speed.

### SUMMARY

This invention provides apparatus and methods for wide format inkjet printing using conventional piezoelectric inkjet print heads to provide a continuous resolution across the entire width of a substrate. A first exemplary printer in accordance with this invention includes a plurality of inkjet print heads, with each print head having a native print resolution. The print heads are disposed to deposit a fluid on the substrate at the native resolution across an entire width of the substrate without scanning across the width of the substrate. In particular, the printer includes a support structure that has a long axis that spans the width of the substrate. Each of the print heads includes a plurality of inkjet nozzles that are adapted to eject a fluid, such as colored ink, onto the substrate at the native resolution. The plurality of print heads are disposed along the long axis of the support structure so that the inkjet nozzles deposit a fluid at the native resolution across the entire width of the substrate.

Alternative exemplary printers in accordance with this invention print at resolutions greater than the native resolution. In particular, a second exemplary printer in accordance with this invention includes a plurality of inkjet print heads disposed in an array to deposit a fluid on the substrate at the native resolution across an entire width of the substrate without scanning across the width of the substrate. In addition, the print head array may be shifted in a direction parallel to the width of the substrate. The plurality of print heads are used to deposit a fluid on the substrate in multiple passes. In particular, during a first pass, the print head array is located at a first position, and a first image is printed on the substrate. During a second pass, the print head array is shifted to a second position, and a second image is printed on the substrate. The distance between the first and second positions may be set so that the first and second images have a composite resolution that is greater than the native resolution.

A third exemplary printer in accordance with this invention includes multiple print head arrays, with each print head array including a plurality of inkjet print heads adapted to deposit a fluid on the substrate at the native resolution across an entire width of the substrate without scanning across the width of the substrate. Each print head array is shifted in a direction parallel to the width of the substrate relative to adjacent print head arrays. The plurality of print head arrays are used to print an image on the substrate. The distance between adjacent print head arrays may be set so that the printed image has a composite resolution that is greater than the native resolution.

A fourth exemplary printer in accordance with this invention includes multiple print head arrays, with each print head array including a plurality of inkjet print heads adapted to deposit a fluid on the substrate at the native resolution across an entire width of the substrate without scanning across the width of the substrate. Each print head array is shifted in a direction parallel to the width of the substrate relative to adjacent print head arrays. The plurality of print head arrays are used to deposit a fluid on the substrate in multiple passes. In particular, during a first pass, the plurality of print head arrays is located at a first position, and a first image is printed on the substrate. During a second pass, the plurality of print head arrays is shifted to a second position, and a second image is printed on the substrate. The distance between adjacent print head arrays, and the distance between the first and second positions may be set so that the first and second images have a composite resolution that is greater than the native resolution of the array.

A fifth exemplary printer in accordance with this invention includes multiple print head arrays, with each print head array including a plurality of inkjet print heads adapted to deposit a fluid on the substrate at the native resolution across an entire width of the substrate without scanning across the width of the substrate. Each print head array may be independently shifted in a direction parallel to the width of the substrate relative to adjacent print head arrays. The plurality of print head arrays are used to print an image on the substrate. The distance between adjacent print head arrays may be set so that the printed image has a composite resolution that is greater than the native resolution. Additionally, the print head arrays may be independently shifted to print at resolutions independent of other print head arrays.

A sixth exemplary printer in accordance with this invention includes a support structure that has a long axis that spans the width of the substrate, and a plurality of print heads are disposed in an array along the long axis of the support structure so that the inkjet nozzles deposit a fluid on the substrate at the native resolution across the entire width of the substrate without scanning across the width of the substrate. The print head array may be rotated about a pivot point on the support structure to deposit a fluid on the substrate at any resolution greater than the native resolution. A variation of this embodiment includes multiple print head arrays disposed on the support structure, in which each print head array may be independently rotated about a respective pivot point on the support structure to deposit a fluid on the substrate at any resolution.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a perspective view of an exemplary printer in accordance with this invention;

FIGS. 2A-2B are top plan views of the exemplary printer of FIG. 1;

FIG. 3A-3C are cross-sectional views of the printer of FIG. 2A along the line A-A in the direction of the arrows;

FIG. 4 is a bottom plan view of the support structure of FIG. 3A;

FIG. 5 is an enlarged view of a portion of the support structure of FIG. 4;

FIGS. 6A-6E are simplified views of an exemplary method of printing in accordance with this invention;

FIG. 7 is a bottom plan view of an alternative support structure in accordance with this invention;

FIG. 8 is a simplified view of the print head arrays of FIG. 7;

FIG. 9 is a bottom plan view of another alternative support structure in accordance with this invention;

FIGS. 10A and 10B are simplified views of the print head arrays of FIG. 9;

FIGS. 11A-11D are simplified views of an alternative exemplary method of printing in accordance with this invention;

FIGS. 12A-12B are simplified views of another alternative exemplary method of printing in accordance with this invention;

FIG. 13A-13B are simplified views of an exemplary method of interlaced printing in accordance with this invention;

FIG. 14 is a top plan view of an alternative exemplary printer in accordance with this invention;

FIG. 15 is a bottom plan view of the support structures of FIG. 14;

FIGS. 16A-16B are simplified views of an alternative exemplary method of interlaced printing in accordance with this invention;

FIG. 17. is a top plan view of another alternative exemplary printer in accordance with this invention; and

FIG. 18 is a top plan view of yet another alternative exemplary printer in accordance with this invention.

### DETAILED DESCRIPTION

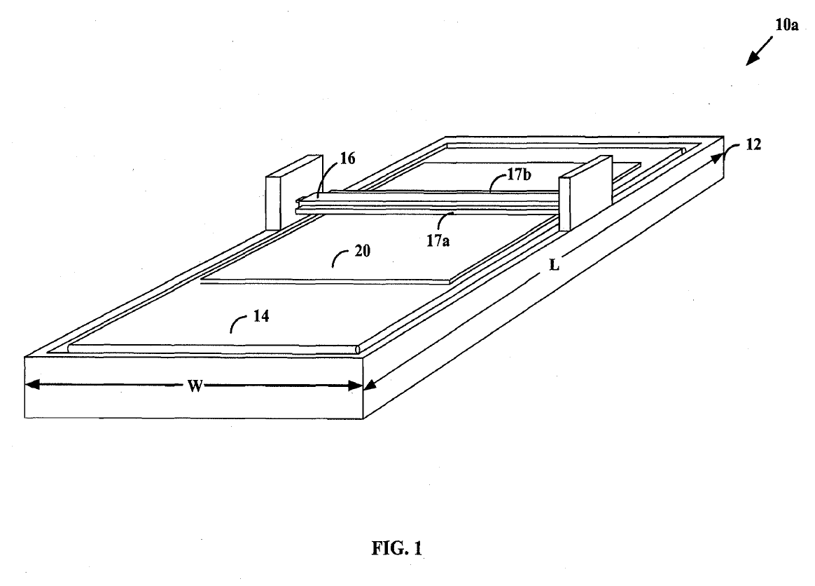

Referring to FIGS. 1-3, a first exemplary embodiment of a printer in accordance with this invention is described. Printer 10a includes base 12, conveyor 14 and support structure 16. Printer 10a has a width W aligned substantially parallel to an x-axis, and a length L aligned substantially parallel to a y-axis. Support structure 16 may be a rigid elongate structure that spans the width W of printer 12, and that is used to support one or more arrays 34 of ink jet print heads 24. Support structure 16 has an origin 18, and a long axis that is parallel to the x-axis. Conveyor 14 has an end 22 that is aligned with the y-axis. Printer 10a also may include one or more curing stations 17 coupled to support structure 16 and/or print head arrays 34.

In particular, support structure 16 may include curing stations 17a and 17b attached to first and second sides, respectively, of support structure 16 to cure or dry fluids deposited by print heads 24 on substrate 20 during printing. Curing stations 17 may include ultraviolet (“UV”) lamp systems, “cold UV” lamp systems, UV light emitting diode (“UV-LED”) lamp systems, infrared heat systems, electron-beam (“e-beam”) curing systems, hot air convection systems or other similar systems for curing or heating fluids.

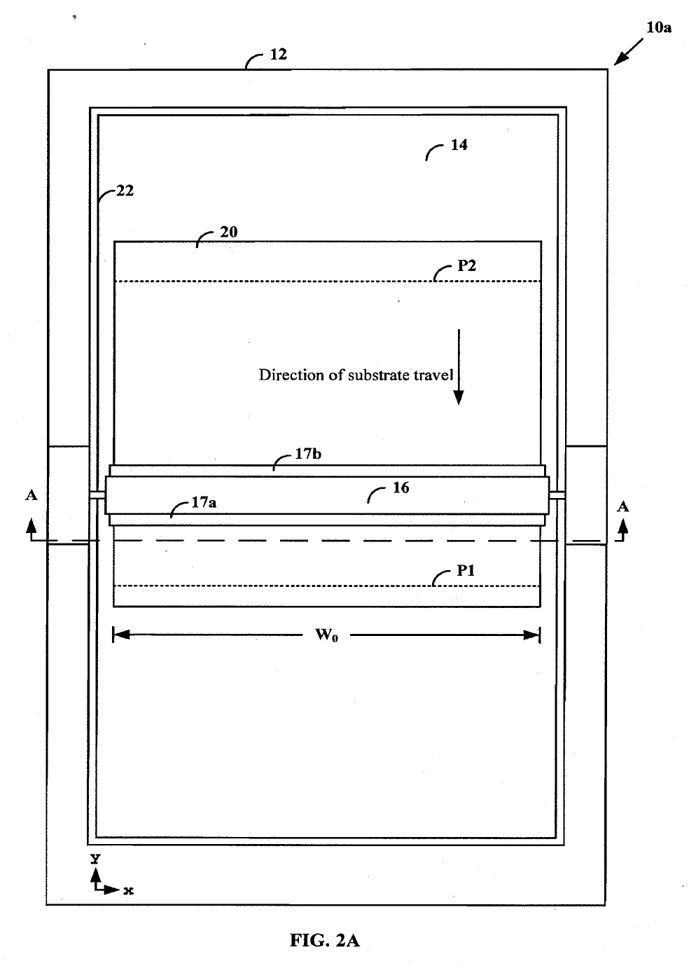

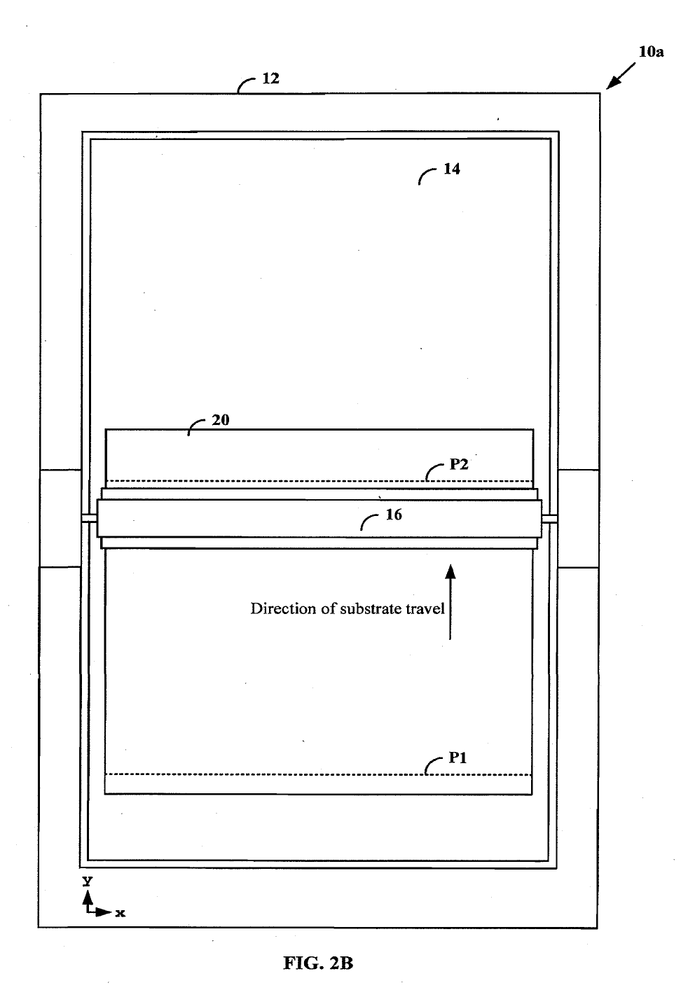

A substrate 20 is disposed on conveyor 14, which is adapted to move in either direction along the y-axis. In particular, conveyor 14 is adapted to move substrate 20 under support structure 16 as ink jet print heads 24 deposit fluids on the substrate. Thus, as shown in FIG. 2A, during a first pass, conveyor 14 may move in a first direction so that print heads 24 deposit fluids across the width of substrate 20 from a first position P1 to a second position P2 on substrate 20. As shown in FIG. 2B, during a second pass, conveyor 14 may move in a second direction so that print heads 24 deposit fluids across the width of substrate 20 from second position P2 to first position P1 on substrate 20. Positions P1 and P2 may be any positions along the length of substrate 20.

While moving along the y-axis, conveyor 14 maintains substrate 20 at a fixed location along the x-axis. Thus, conveyor 14 may be a flexible “endless belt” disposed around a rigid vacuum table, a moveable vacuum table or other similar device for controlling the x- and y-axis locations of substrate 20. Substrate 20 has a width W₀, and may be a metal, glass, wood, plastic, paper or other similar substrate or combination thereof.

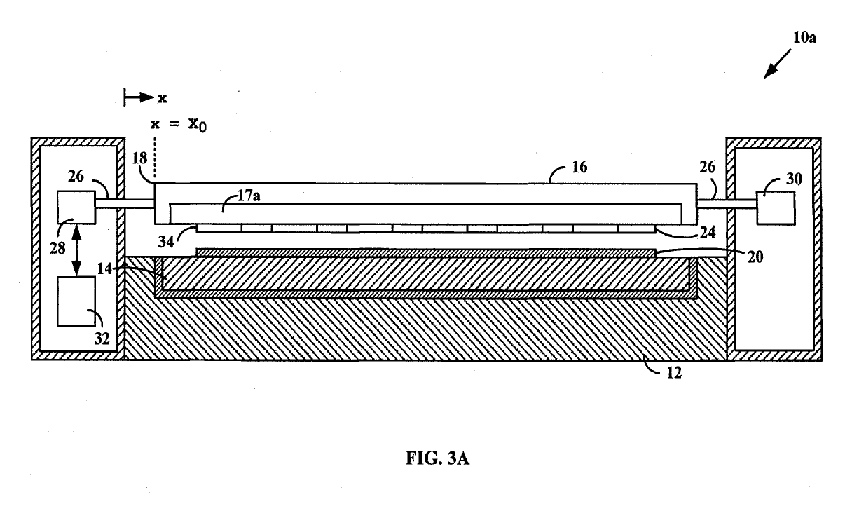

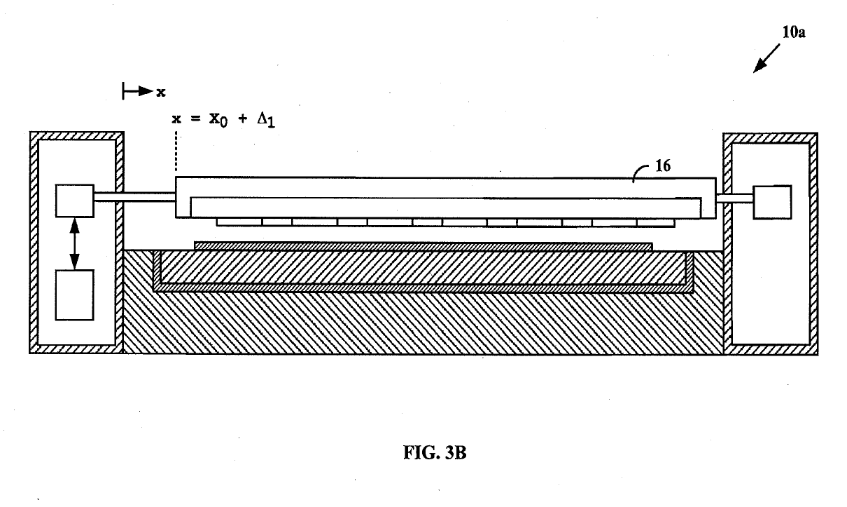

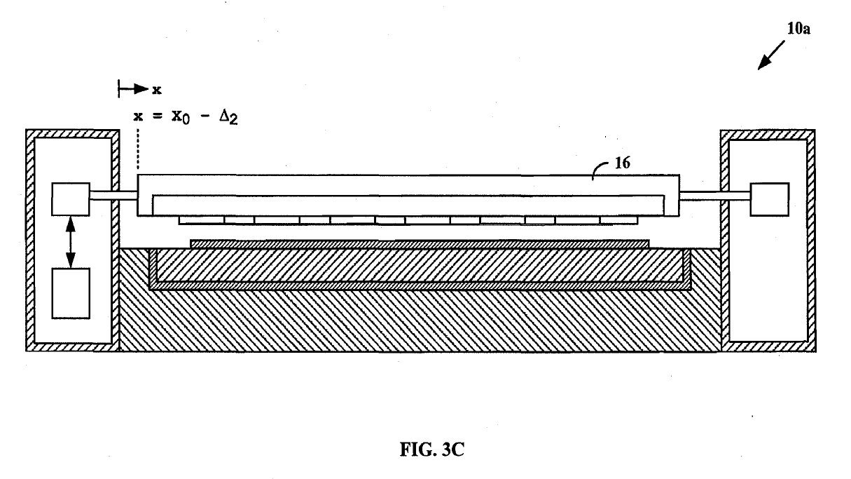

Support structure 16 is disposed above substrate 20, and is adapted to control the x-axis location of print heads 24. In particular, as shown in FIG. 3A, support structure 16 may include arms 26 that are coupled to an actuator 28 and position detector 30. Actuator 28 may be a linear actuator or other similar device that may be used to provide linear motion to support structure 16. Position detector 30 may be a linear encoder or other similar device that may be used to accurately determine the x-axis location of support structure 16. A controller 32 may be coupled to actuator 28 and position detector 30 to precisely control the x-axis location of support structure 16. For example, controller 32 may direct actuator 28 to locate origin 18 of support structure 16 at a position x=X₀. As illustrated in FIGS. 3B and 3C, controller 32 also may direct actuator 28 to move support structure 16 so that origin 18 is located at x=X₀+Δ₁ or x=X₀−Δ₂, respectively. Δ₁ and Δ₂ may be the same distance or may be different distances.

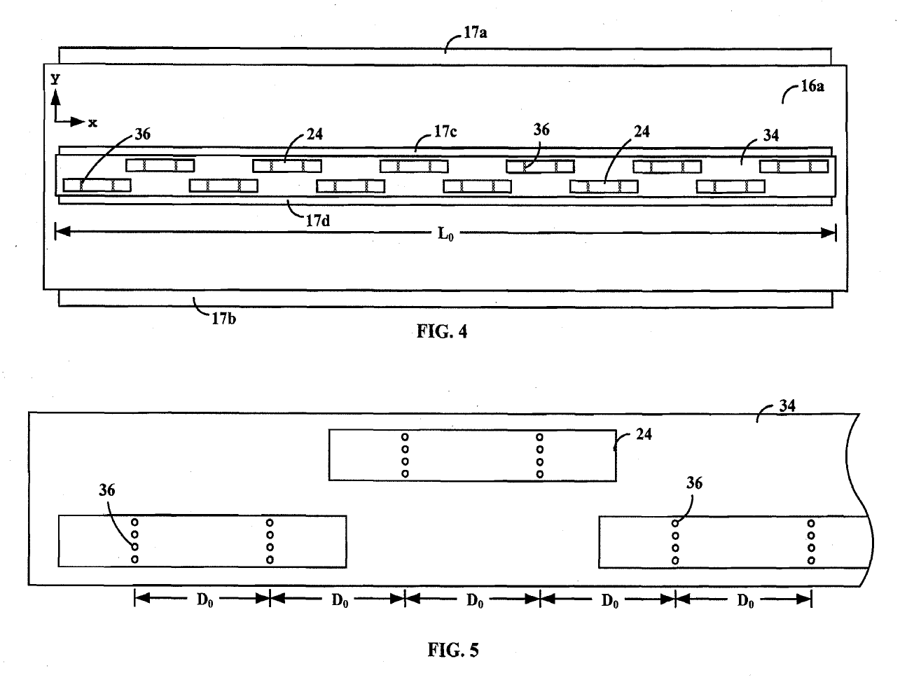

Referring now to FIGS. 4 and 5, an exemplary embodiment of support structure 16 is described. Support structure 16a includes an array 34 of print heads 24, each of which includes inkjet nozzles 36 that may be individually controlled to eject a fluid onto substrate 20. Fluids may be delivered to print heads 24 from a fluid reservoir system (not shown) via conventional tubing systems, via channels in support structure 16a that couple the print heads to the fluid reservoir system, or by other similar systems. Exemplary fluids that may be ejected by inkjet nozzles 36 include colored inks, such as cyan, magenta, yellow or black (“CMYK”) inks, as are commonly used in the printing industry. Colored inks also may include light cyan, light magenta, light yellow, light black, red, blue, green, orange, white, gray, spot colors, and other similar colored inks. The inks may be solvent-based inks, dye sublimation inks, cationic inks, UV curable inks, e-beam curable inks, or other similar inks. In addition, inkjet nozzles 36 also may be used to eject fluids other than colored inks, such as clear coat finishes, UV protective finishes, and other similar fluids.

Print head array 34 may include curing stations 17c and 17d attached to first and second sides, respectively, of print head array 34 to cure or dry fluids deposited by print heads 24 on substrate 20 during printing. Curing stations 17c and 17d may include UV lamp systems, cold UV lamp systems, UV-LED lamp systems, infrared heat sources, e-beam lamp systems, hot air convection systems or other similar systems for curing or drying fluids.

Array 34 in FIG. 4 includes twelve print heads 24, each of which includes eight inkjet nozzles 36. Persons of ordinary skill in the art will understand that print head arrays 34 in accordance with this invention may include more or less than twelve print heads 24, and each print head 24 may include more or less than eight inkjet nozzles 36. Inkjet nozzles 36 are spaced apart along the long axis of the print head 24 by a dot pitch D₀. The resolution of each print head 24, referred to as the native resolution R₀, equals the inverse of the dot pitch (i.e., 1/D₀). The native resolution is typically specified in dots per unit length, such as 37.5 dots per inch (“DPI”).

Print heads 24 are disposed on array 34 such that the long axis of each print head 24 is aligned in parallel with the long axis of the array and with the long axis of support structure 16. Further, print heads 24 are staggered in the y-direction along the length L₀ of print head array 34 so that the print head array has a continuous resolution R₀ along the entire length L₀. In this regard, if the length L₀ of print head array 34 is substantially equal to the width W₀ of substrate 20, print head array 34 may be used to print across the entire width W₀ of substrate 20 at native resolution R₀ without scanning across width W₀ of substrate 20. Thus, in a single pass, printer 10a may print an image on substrate 20 at a continuous resolution R₀ across the entire width W₀ of substrate 20 without scanning across width W₀ of substrate 20.

In addition, printer 10a may be used to print an image across the entire width of substrate 20 at resolutions greater than native resolution R₀ without scanning across width W₀ of substrate 20. In particular, referring to FIGS. 2 and 3, during a first pass, controller 32 positions origin 18 of support structure 16 at a first x-axis position (e.g., x=X₀), and print head array 34 then prints a first image on substrate 20 as conveyor 14 moves substrate 20 in a first direction from P1 to P2. During a second pass, controller 30 positions origin 18 of support structure 16 at a second x-axis position (e.g., x=X₀+Δ₁), and print head array 34 then prints a second image on substrate 20 as conveyor 14 moves substrate 20 in a second direction from P2 to P1. If Δ₁ is a fraction of dot pitch D₀, this technique may be used to print an image across the entire width of substrate 20 at a composite resolution that is greater than the native resolution R₀. For example, if Δ₁=D₀/2, printer 10a prints the image across the entire width of substrate 20 at a composite resolution of 2×R₀. Further, if this process is repeated, and Δ₁ is further decreased, printer 10a may be used to print at even higher composite resolutions.

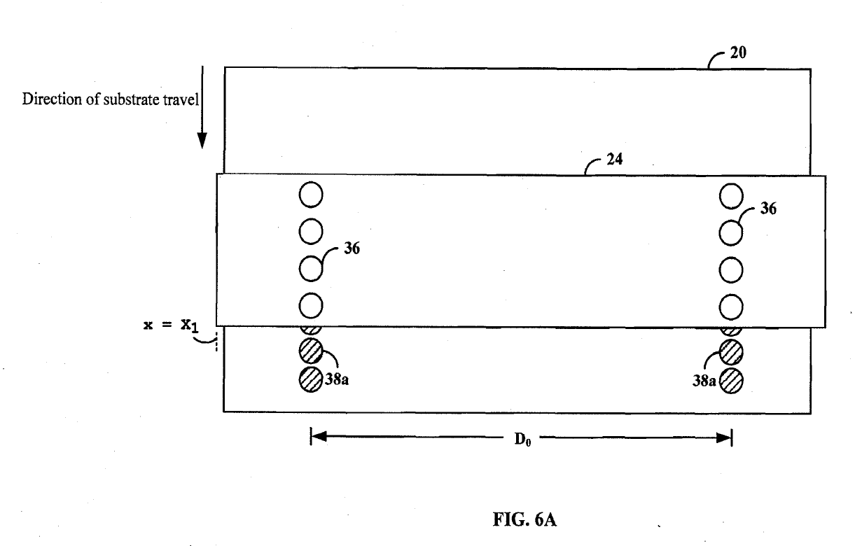

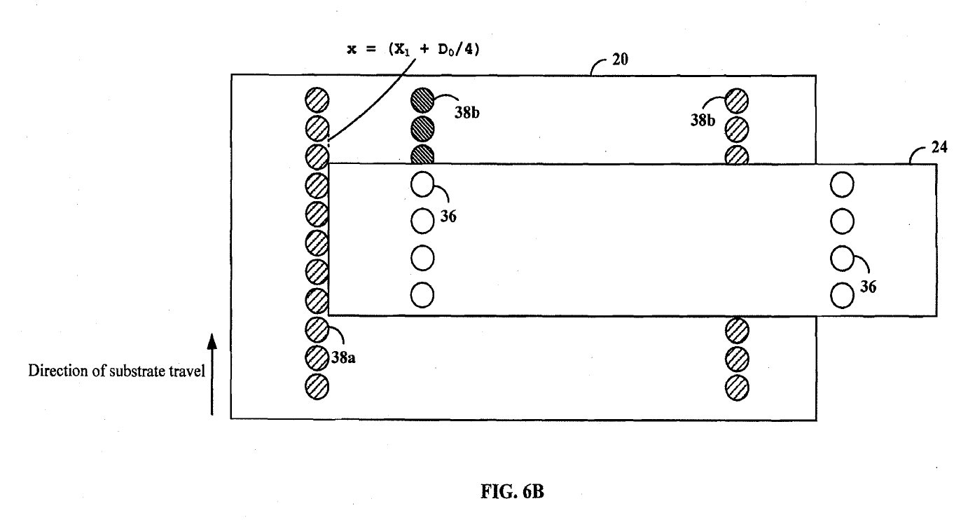

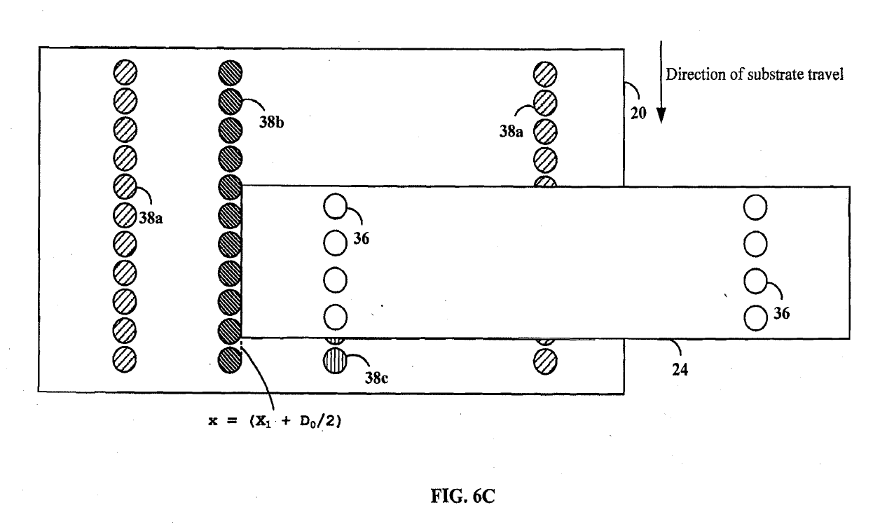

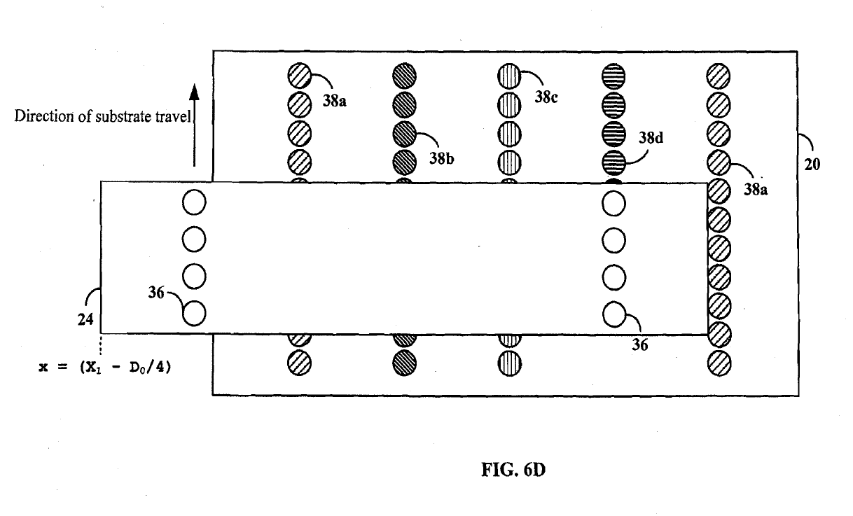

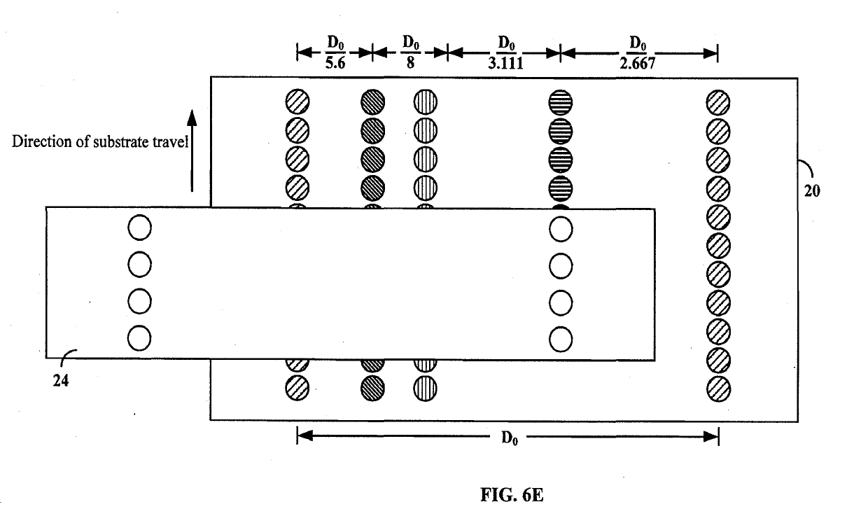

For example, FIGS. 6A-6D illustrate how printer 10a may be used to print an image across the entire width of substrate 20 at a resolution of 4×R₀. Persons of ordinary skill in the art will understand that the described process typically will be used with a print head array 34 that has multiple print heads 24 disposed along the length of the array, and that provides a continuous resolution R₀ along the entire length L₀. To simplify the drawings, however, only a single print head 24 is illustrated in FIGS. 6A-6D. Exemplary print head 24 includes eight ink jet nozzles 36, which include two sets of ink jet nozzles, with each set adapted to print colored inks on substrate 20. Print head 24 has a native resolution R₀ (e.g., 37.5 DPI).

As shown in FIG. 6A, during a first pass, print head 24 is located at a first x-axis position, x=X₁, conveyor 14 moves substrate 20 in a first direction, and print head 24 prints a first image 38a on substrate 20. Next, as shown in FIG. 6B, during a second pass, print head 24 is located at a second x-axis position, x=(X₁+D₀/4), conveyor 14 moves substrate 20 in a second direction, and print head 24 prints a second image 38b on substrate 20. Next, as shown in FIG. 6C, during a third pass, print head 24 is located at a third x-axis position, x=(X₁+D₀/2), conveyor 14 moves substrate 20 in the first direction, and print head 24 prints a third image 38c on substrate 20. Finally, as shown in FIG. 6D, during a fourth pass, print head 24 is located at a fourth x-axis position, x=(X₁−D₀/4), conveyor 14 moves substrate 20 in the second direction, and print head 24 prints a fourth image 38d on substrate 20. Persons of ordinary skill in the art will understand that the fourth x-axis position alternatively could be x=(X₁+3D₀/4).

Thus, after four passes, print head 24 prints images 38a-38d across the entire width of substrate 20 at a composite resolution of 4×R₀ (e.g., 150 DPI). In general, therefore, to print across the entire width of substrate 20 at a composite resolution of NR₀, printer 10a prints in N passes, and shifts the x-axis position of support structure 16 (and therefore print heads 24) between each pass. The amount of each shift may be uniform or non-uniform. For example, as shown in FIGS. 6A-6D, support structure 16 is uniformly shifted by integer multiples of D₀/N between each pass. Persons of ordinary skill in the art will understand that support structure 16 may be shifted by arbitrary amounts and/or non-uniformly between each pass. For example, FIG. 6E illustrates printing in four passes at a composite resolution of 4×R₀, but shifting support structure by D₀/5.6, D₀/8, D₀/3.111 and D₀/2.667 between each pass.

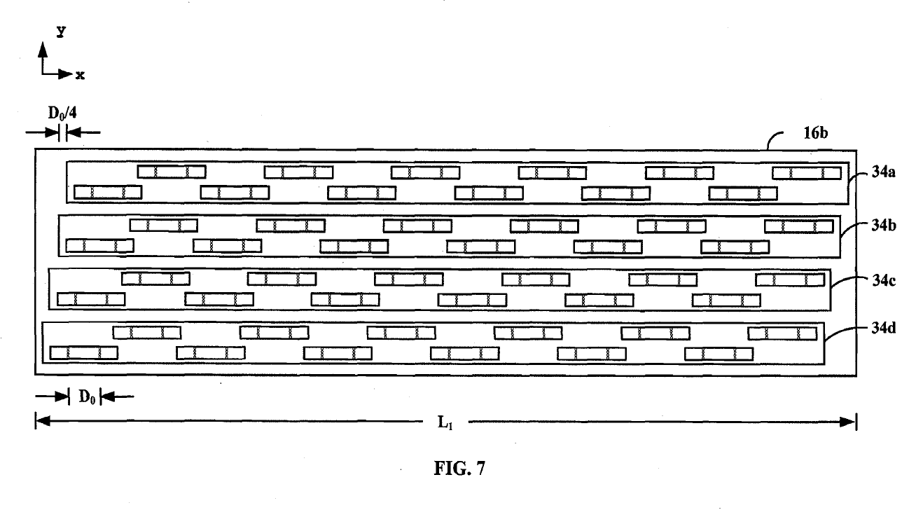

Apparatus and methods in accordance with this invention also may print across the entire width of substrate 20 at a resolution greater than native resolution R₀ without requiring multiple printing passes. In particular, multiple print head arrays 34 may be grouped on support structure 16, with each print head array 34 offset in the x-direction from adjacent print head arrays. For example, FIG. 7 illustrates an alternative exemplary support structure 16b that includes four print head arrays 34a-34d staggered in the y-direction, with each print head array 34 offset in the x-direction by D₀/4 from adjacent print head arrays 34.

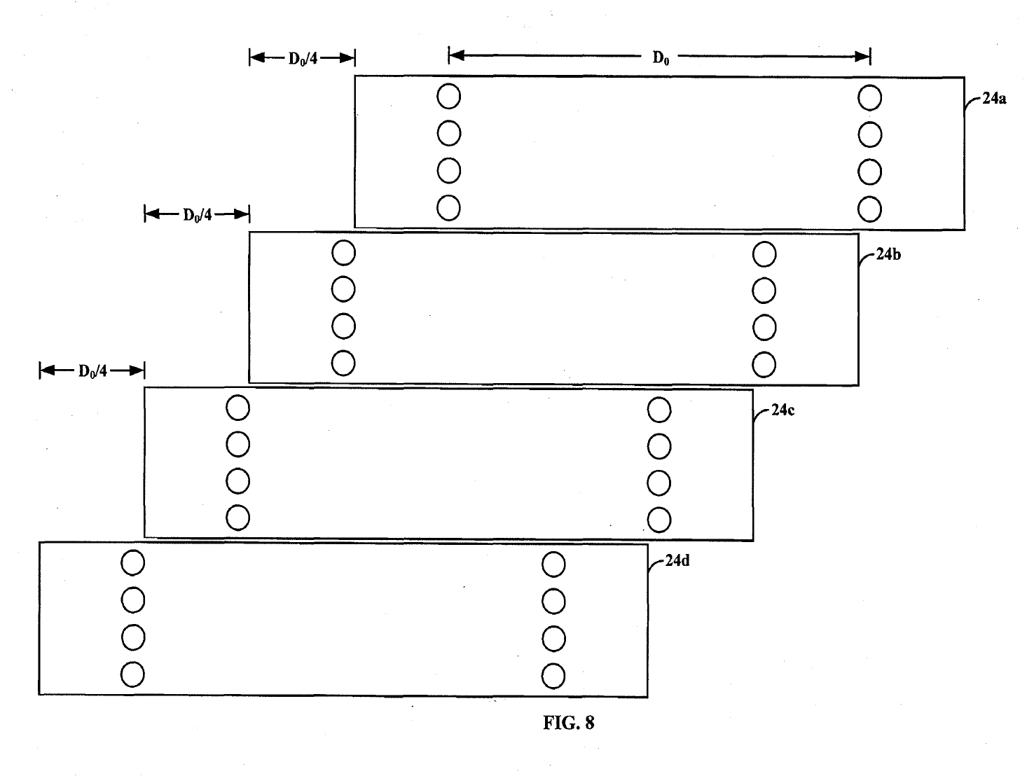

FIG. 8 illustrates a simplified view of FIG. 7, with a single print head 24a 24d from each of print head arrays 34a-34d, respectively. In this example, each print head array 34 has a native resolution R₀=1/D₀, and the group of print head arrays 34a-34d provides a continuous resolution of 4×R₀ (e.g., 150 DPI) along the entire length L₁ of support structure 16b. Thus, if L₁ substantially equals width W₀ of substrate 20, support structure 16b may be used to print across the entire width W₀ of the substrate 20 at a composite resolution of 4×R₀. Persons of ordinary skill in the art will understand that more than or less than four print head arrays 34 may be grouped together on support structure 16, depending on the desired composite resolution.

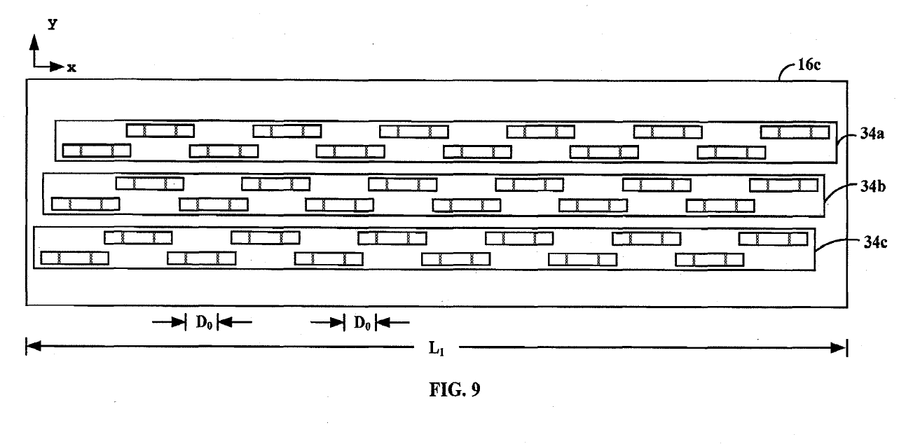

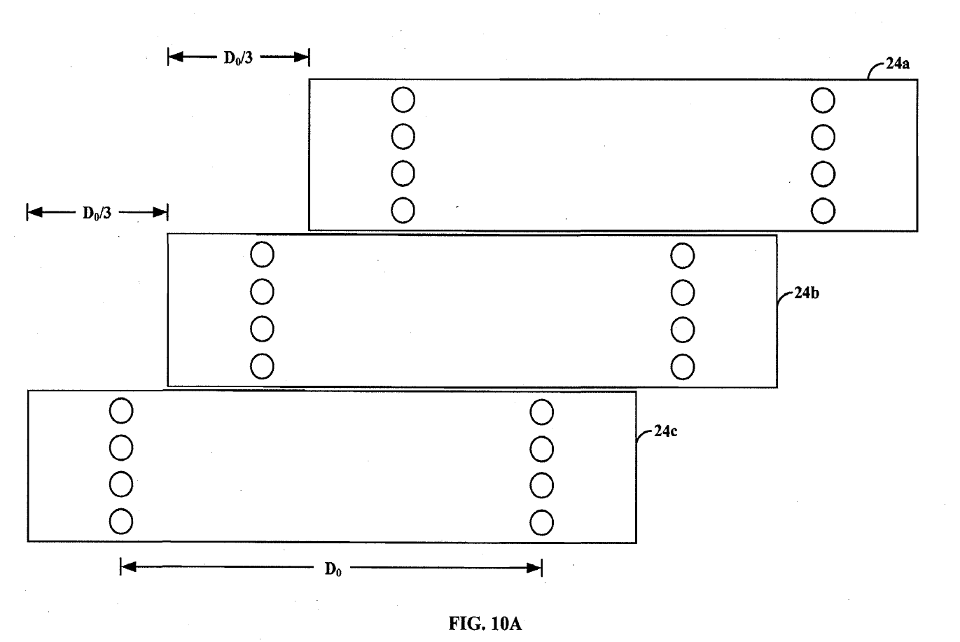

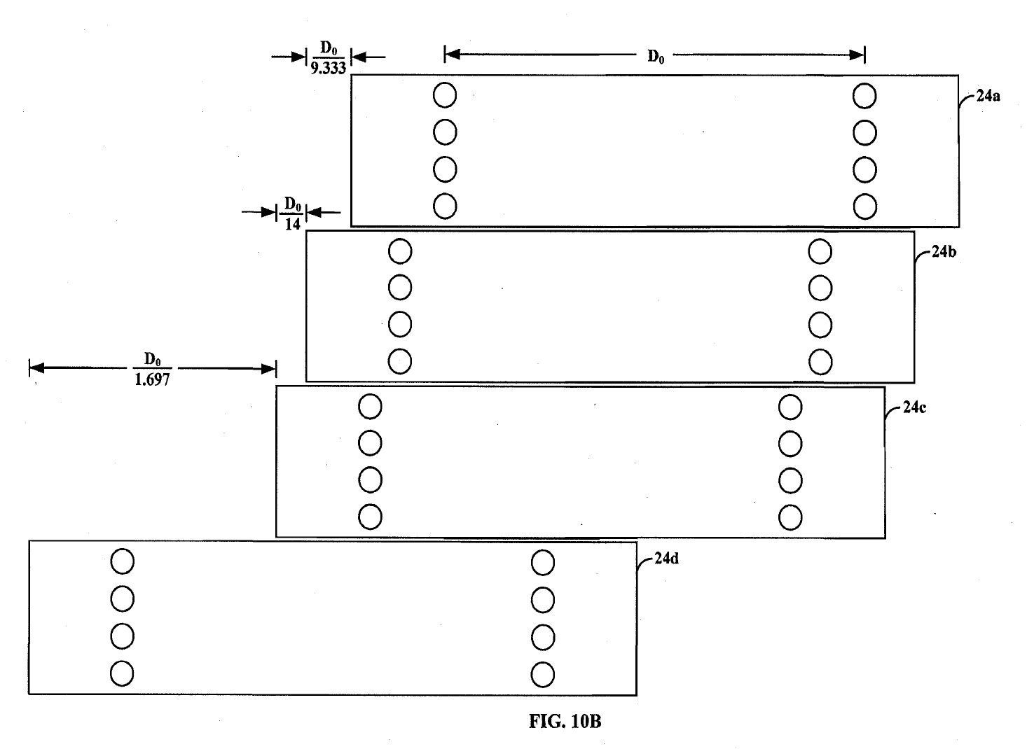

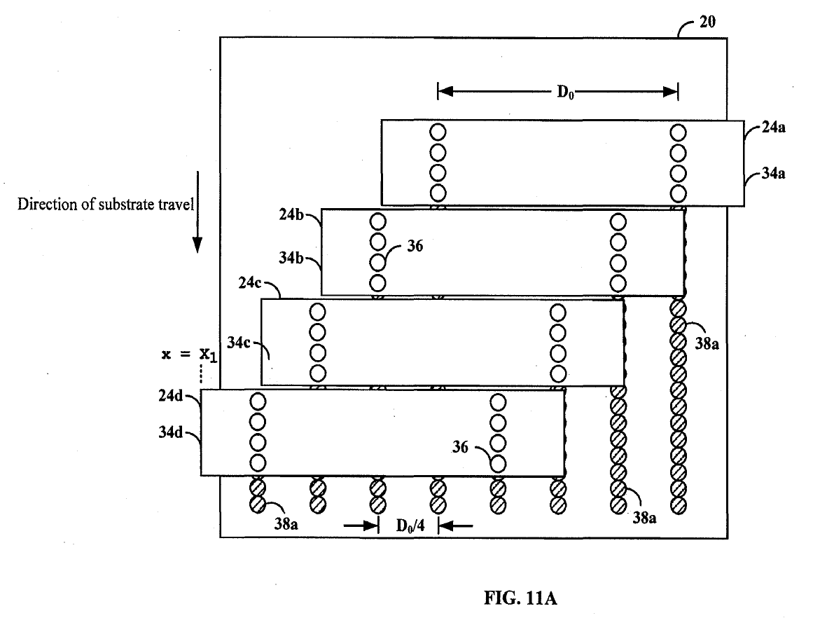

For example, FIG. 9 illustrates an alternative exemplary support structure 16c that includes three print head arrays 34a-34c staggered in the y-direction, with each print head array 34 offset in the x-direction by D₀/3 from adjacent print head arrays 34. FIG. 10A illustrates a simplified view of FIG. 9, with a single print head 24a-24c from each of print head arrays 34a-34c, respectively. In this example, the group of print head arrays 34a-34c has a composite resolution 3×R₀ (e.g., 112.5 DPI) along the entire length L₁. Thus, support structure 16c may be used to print across the entire width W₀ of the substrate 20 at a composite resolution of 3×R₀.

In general, therefore, to print across the entire width of substrate 20 at a composite resolution of M×R₀, support structure 16 includes M print head arrays 34, with each print head array 34 offset in the x-direction from adjacent print head arrays 34 by D₀/M. Persons of ordinary skill in the art will understand, however, that other x-axis offset values may be used to achieve the same composite resolution, and that the x-axis offset values may be integer or non-integer fractions of D₀ (e.g., D₀/1.697, D₀/14, D₀/9.333, etc.), and may be uniform or non-uniform, such as illustrated in FIG. 10B.

The two techniques described above can be combined to further increase the resolution of printers in accordance with this invention. In particular, to print across the entire width of substrate 20 at a composite resolution of M×N×R₀, printer 10a includes a support structure 16 that includes M print head arrays 34, with each print head array 34 offset in the x-direction by D₀/M from adjacent print head arrays. The support structure 16 may then be used to print in N passes, with an x-axis shift of support structure 16 by multiples of 1/(NR₀) between each pass.

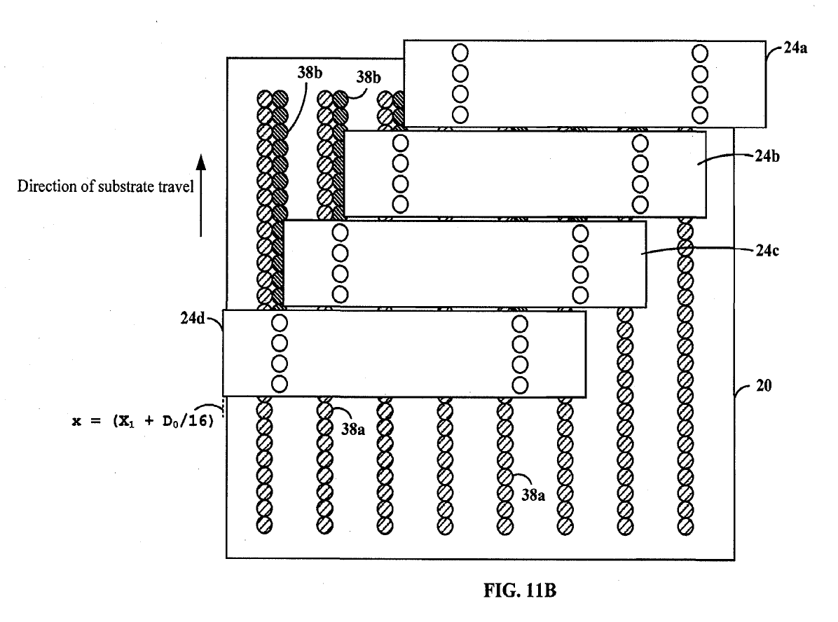

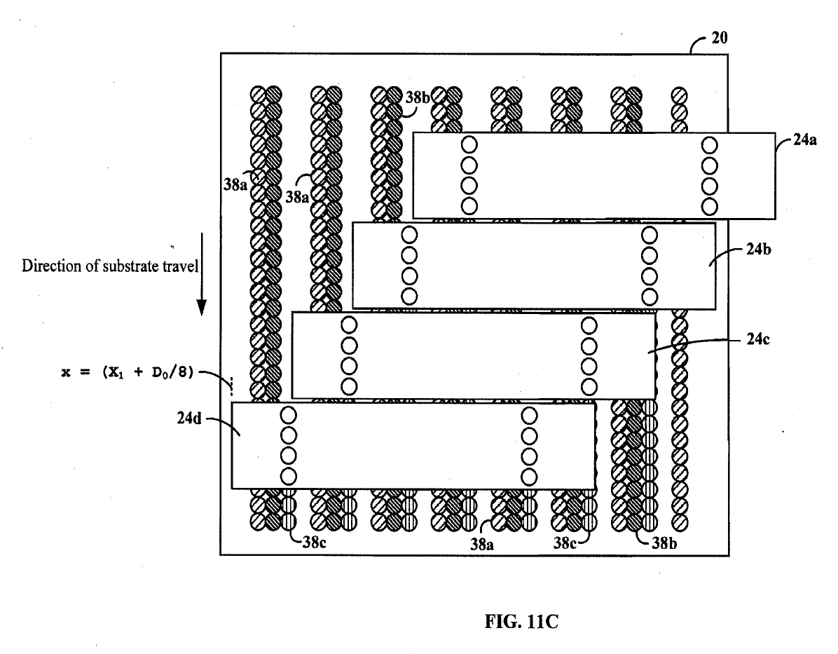

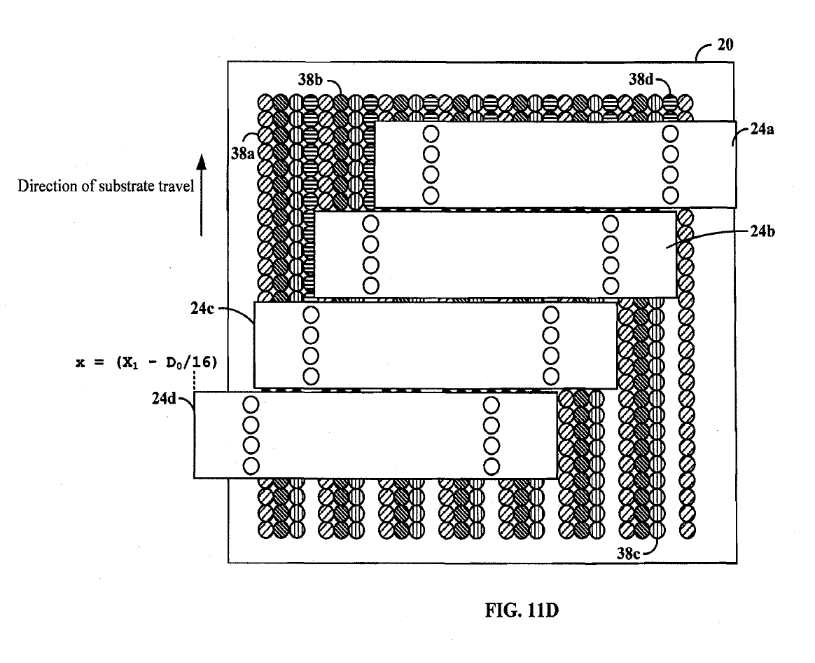

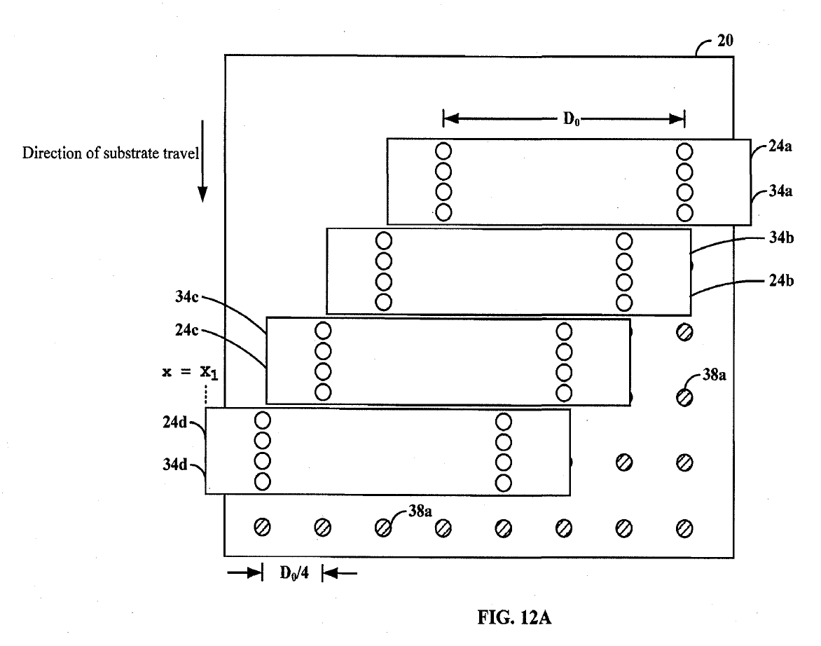

For example, FIGS. 11A-11D illustrate exemplary apparatus and methods in accordance with this invention for printing an image across the entire width of substrate 20 at a resolution of 16×R₀ (e.g., M=N=4). In particular, support structure 16b of FIG. 7 may be used, with four print head arrays 34a-34d staggered in the y-direction and offset from one another in the x-direction by D₀/4. To simplify the drawings in FIGS. 11A-11D, each print head array 34a-34d is shown including only a single print head 24a-24d, respectively. Each exemplary print head 24a-24d includes eight ink jet nozzles 36, and has a native resolution R₀ (e.g., 37.5 DPI). The group of print head arrays 34a-34c print across the entire width of substrate 20 at a composite resolution 4×R₀ (e.g., 150 DPI).

As shown in FIG. 11A, during a first pass, the group of print head arrays 34a-34d is located at a first x-axis position, x=X₁, substrate 20 moves in a first direction, and print heads 24a-24d print a first image 38a on substrate 20. Next, as shown in FIG. 11B, during a second pass, the group of print head arrays 34a-34d is located at a second x-axis position, x=(X₁+D₀/16), substrate 20 moves in a second direction, and print heads 24a-24d print a second image 38b on substrate 20. Next, as shown in FIG. 11C, during a third pass, the group of print head arrays 34a-34d is located at a third x-axis position, x=(X₁+D₀/8), substrate 20 moves in the first direction, and print heads 24a-24d print a third image 38c on substrate 20. Finally, as shown in FIG. 11D, during a fourth pass, the group of print head arrays 34a-34d is located at a fourth x-axis position, x=(X₁−D₀/16), substrate 20 moves in the second direction, and print heads 24a-24d print a fourth image 38d on substrate 20. Persons of ordinary skill in the art will understand that the fourth x-axis position alternatively could be x=(X₁+3D₀/16). Thus, after four passes, the group of print head arrays 34a-34d prints images 38a-38d on substrate 20 at a composite resolution of 4×4×R₀ (e.g., 600 DPI) across the entire width of substrate 20.

Persons of ordinary skill in the art will understand that the sequence of printing steps may be modified from that shown in FIGS. 11A-11D. For example, image 38a may be printed during the first pass, image 38c may be printed during the second pass, image 38d may be printed during the third pass and image 38b may be printed during the fourth pass, and so on. Persons of ordinary skill in the art also will understand that print head arrays 34a-34d may be offset from one another in the x-direction by uniform or non-uniform amounts, and that the group of print head arrays 34a-34d may be shifted by arbitrary amounts and/or non-uniformly between each pass.

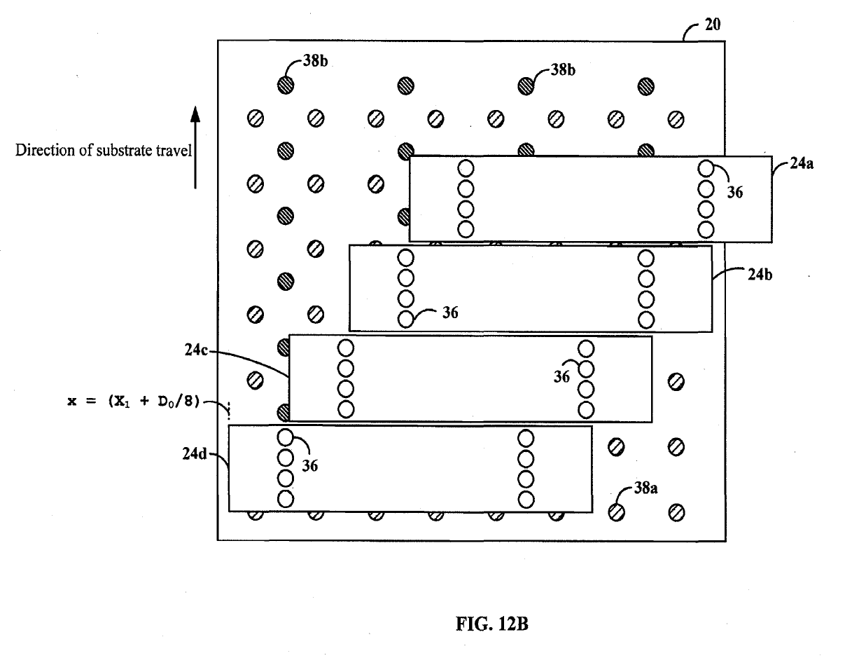

Persons of ordinary skill in the art will further understand that apparatus and methods of this invention may be used to print at non-integer multiples of the native resolution R₀ of print head 24, and all print heads 24 may not be used during each printing step. For example, as shown in FIG. 12A, during a first pass, the group of print head arrays 34a-34d is located at a first x-axis position, x=X₁, substrate 20 moves in a first direction, and print heads 24a-24d print a first image 38a on substrate 20. Next, as shown in FIG. 12B, during a second pass, the group of print head arrays 34a-34d is located at a second x-axis position, x=(X₁+D₀/8), substrate 20 moves in a second direction, and print heads 24b and 24d print a second image 38b on substrate 20, while print heads 24a and 24c are inactive. Thus, after two passes, the group of print head arrays 34a-34d print images 38a and 38b on substrate 20 at a composite resolution of (8/3)×R₀ (e.g., 100 DPI) across the entire width of substrate 20.

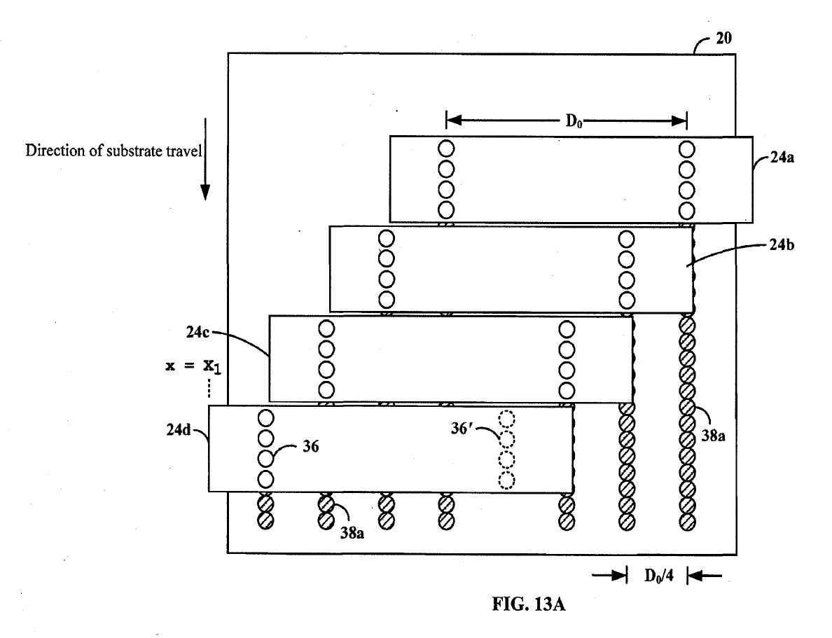

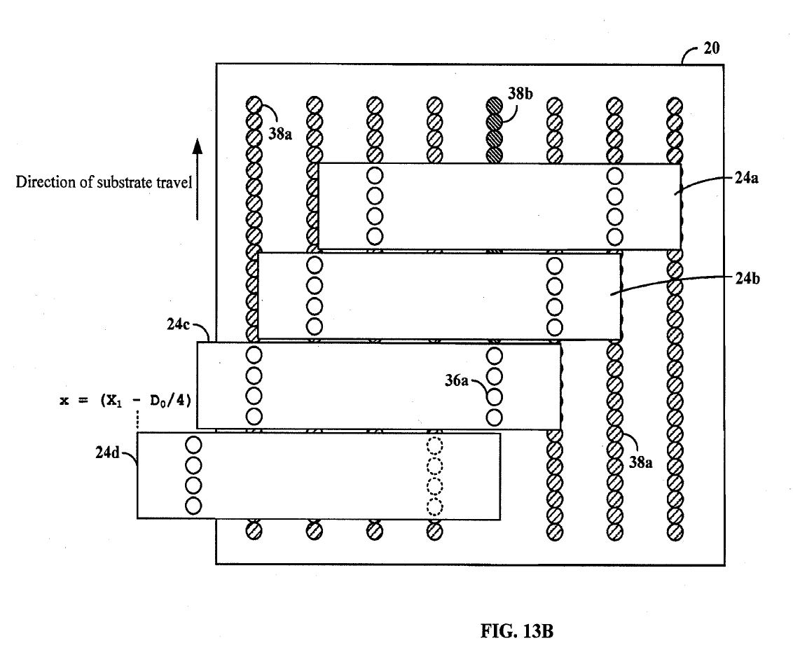

Apparatus and methods in accordance with this invention also may be used to print images on substrate 20 even if one or more inkjet nozzles 36 are defective or inactive. For example, FIG. 13A illustrates a group of print heads 24a-24d offset in the x-direction by D₀/4 from adjacent print heads, for printing at a composite resolution of 4×R₀. However, print head 24d includes one or more defective inkjet nozzles 36′ (shown in dashed lines). The multipass printing techniques of this invention may be used to compensate for such defective inkjet nozzles 36′.

In particular, as shown in FIG. 13A, during a first pass, the group of print heads 24a-24d is located at a first x-axis position, x=X₁, substrate 20 moves in a first direction, and print heads 24a-24d print a first image 38a on substrate 20. Inkjet nozzles 36′, however, are deactivated, and do not print any portion of first image 38a. Next, as shown in FIG. 13B, during a second pass, the group of print heads 24a-24d is located at a second x-axis position, x=(X₁−D₀/4), substrate 20 moves in a second direction, and only inkjet nozzles 36a of print head 24c are used to print a second image 38b on substrate 20. In this regard, inkjet nozzles 36a of print head 24c may be used to fill in the portion of first image 38a that could not be completed because of the defective inkjet nozzles 36′ on print head 24d. Persons of ordinary skill in the art will understand that inkjet nozzles 36 from print heads 24a or 24b alternatively could have been used to compensate for defective inkjet nozzles 36′ by shifting the group of print heads 24a-24d to an appropriate x-axis position for the second pass.

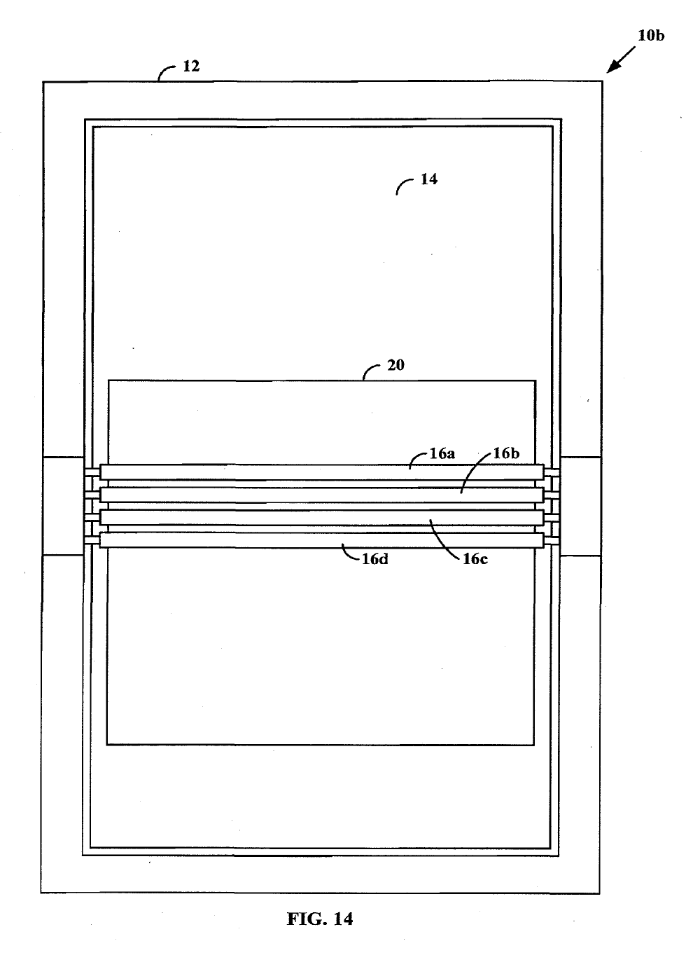

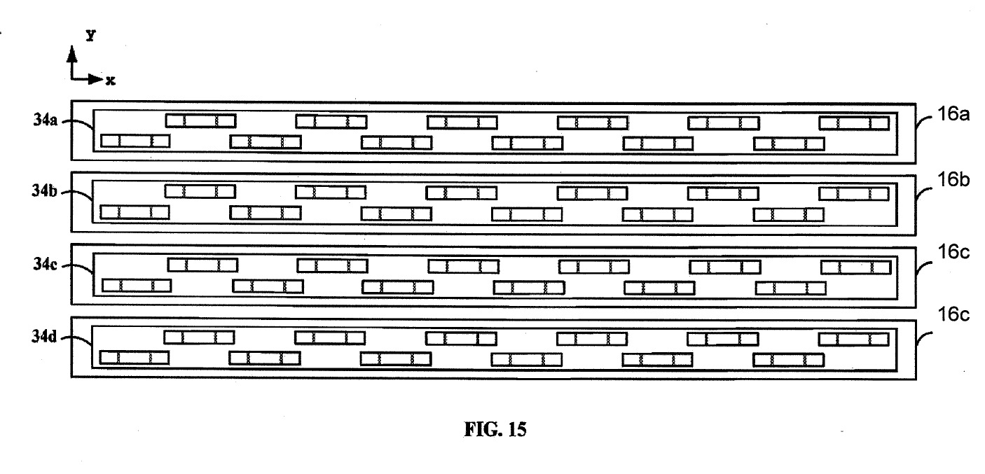

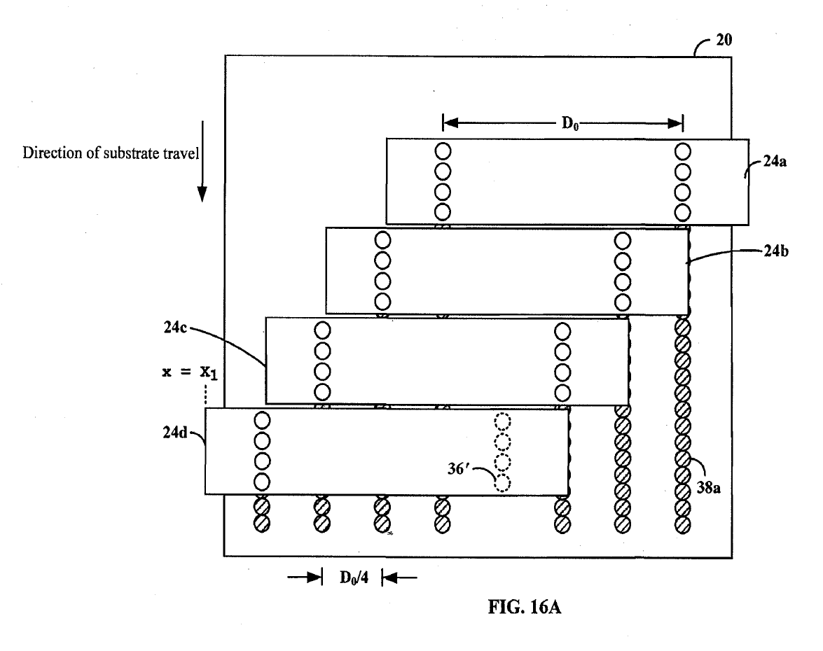

In the embodiments described above, multiple print head arrays 34 are grouped together on a single support structure 16, and the group is collectively shifted along the x-axis. Referring now to FIGS. 14-15, an alternative exemplary printer in accordance with this invention is described in which each print head array 34 may be independently shifted along the x-axis. In particular, exemplary printer 10b includes multiple support structures 16₁-16₄, each of which spans the width W of printer 12 and is used to support one or more print head arrays 34. For example, support structures 16₁-16₄ may include print head arrays 34a-34d, respectively. Further, each support structure 16₁-16₄, may be independently shifted to control the x-axis location of print head arrays 34a-34d.

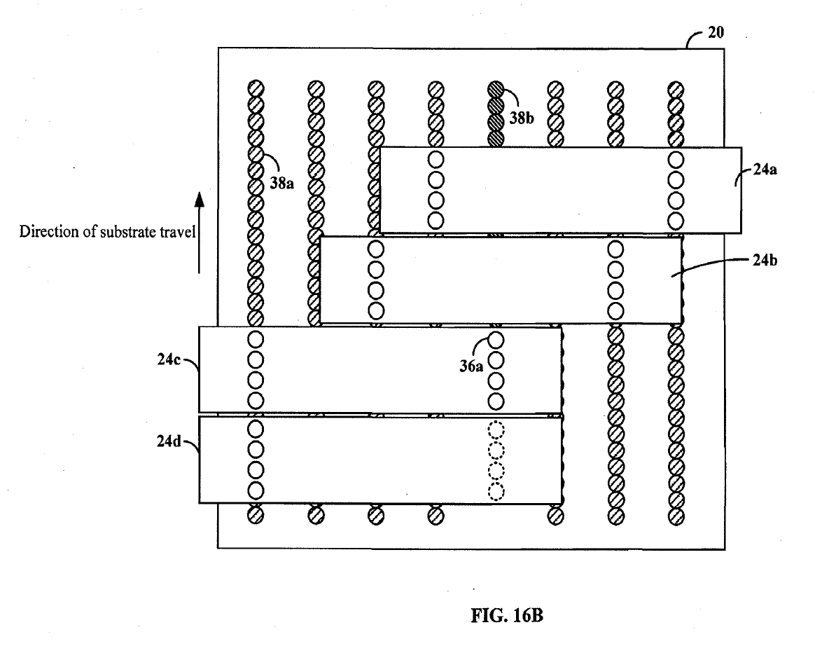

FIG. 16A illustrates a simplified view of FIG. 15, with a single print head 24a-24d from each of print head arrays 34a-34d, respectively. In this example, each print head array 34 has a native resolution R₀=1/D₀. Further, support structures 16₁-16₄ may be individually positioned so that print head arrays 34a-34d provide a continuous resolution of 4×R₀ (e.g., 150 DPI). In addition, multipass printing techniques of this invention may be used to compensate for defective inkjet nozzles, such as inkjet nozzles 36′ on print head 24d.

In particular, during a first pass, support structures 16₁-16₄ are individually positioned so that print head 24d is at a first x-axis position, x=X₁, and all other print heads 24b-24d are positioned to provide a continuous resolution of 4×R₀. As substrate 20 moves in a first direction, print heads 24a-24d print a first image 38a on substrate 20. Inkjet nozzles 36′, however, are deactivated, and do not print any portion of first image 38a. Next, as shown in FIG. 16B, during a second pass, support structures 16₁-16₄ are individually positioned so that print head 24c is located at a the first x-axis position, x=X₁. As substrate 20 moves in a second direction, only inkjet nozzles 36a of print head 24c are used to print a second image 38b on substrate 20. In this regard, inkjet nozzles 36a of print head 24c may be used to fill in the portion of first image 38a that could not be completed because of the defective inkjet nozzles 36′ on print head 24d. Persons of ordinary skill in the art will understand that inkjet nozzles 36 from print heads 24a or 24b alternatively could have been used to compensate for defective inkjet nozzles 36′ by shifting print heads 24a or 24b to an appropriate x-axis position for the second pass.

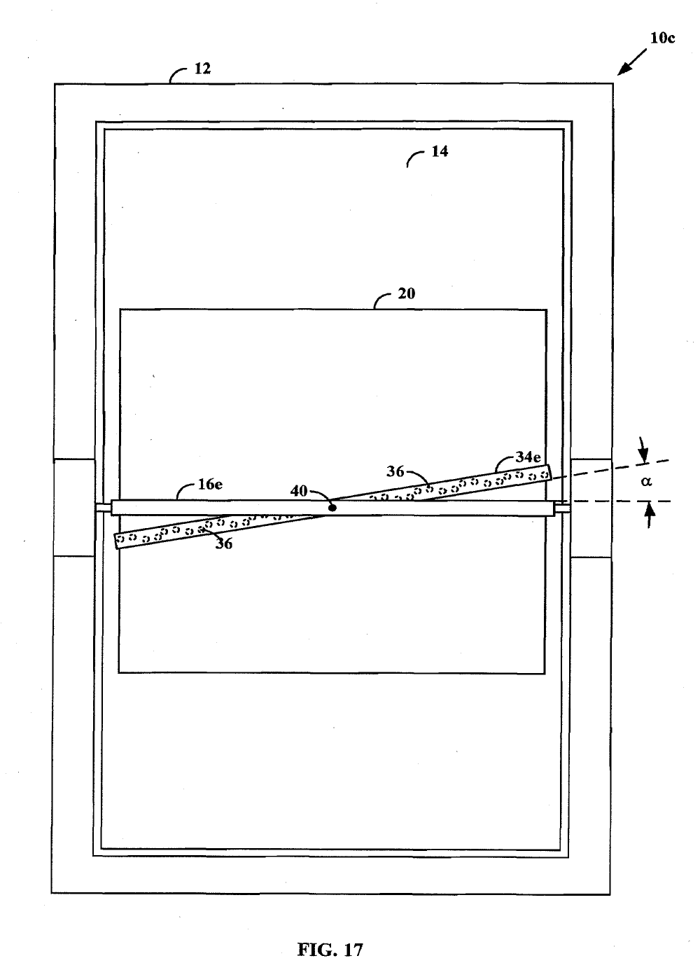

In the embodiments described above, one or more print head arrays 34 are disposed on one or more support structures 16, and the print head arrays are shifted individually or collectively along the x-axis to achieve a desired composite resolution that exceeds the native resolution of each print head. Referring now to FIG. 17, another exemplary printer in accordance with this invention is described in which print head arrays are rotated about an axis to achieve any desired print resolution. In particular, exemplary printer 10c includes support structure 16e that spans the width W of printer 12 and is used to support a print head array 34e that includes multiple print heads (not shown) that have inkjet nozzles 36 disposed to provide a continuous resolution of R₀ across the entire width of substrate 20. In addition, print head array 34e is coupled to support structure 16e at pivot point 40, and may be rotated about the pivot point by an angle α. As α increases from 0 to 90°, the x-axis resolution increases. In this regard, by controlling the pivot angle α, any desired print resolution may be achieved.

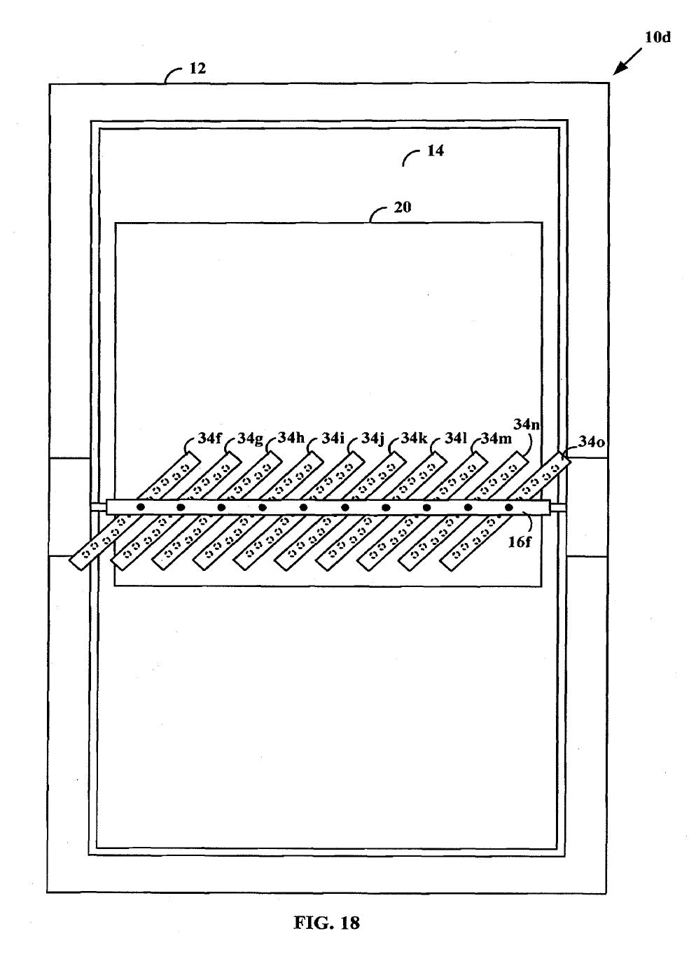

FIG. 18 illustrates another exemplary printer in accordance with this invention that uses multiple pivotable print head arrays 34f-34o. In particular, exemplary printer 10d includes support structure 16f that spans the width W of printer 12 and is used to support print head arrays 34f-34o that each include multiple print heads (not shown) that have inkjet nozzles 36 disposed to provide a resolution R₀ across the entire width of substrate 20. Print head arrays 34f-34o are coupled to support structure 16f at pivot points and may be individually rotated about their respective pivot points to provide any desired print resolution. Multiple print head arrays 34f-34o increase the printing width that may be achieved when using very high pivot angles.

The foregoing merely illustrates the principles of this invention, and various modifications can be made by persons of ordinary skill in the art without departing from the scope and spirit of this invention.

1-45. (canceled)

46. A printer comprising:
a conveyor defining an X direction (W) and a Y direction (L) perpendicular to the X direction, the conveyor configured to receive a substrate of maximum width W2 in the X direction and to move the substrate linearly in the Y direction;
a first array of multiple inkjet print heads distributed along a length of the first array;
where the print heads have a prescribed native resolution and a prescribed dot pitch;
at least one support, spanning the conveyor in the X direction, where the first array is pivotably mounted at its midpoint to the support, where the first array is pivotable about an axis perpendicular to the X and Y directions, and where during printing the array is pivoted sufficient to reduce and compress a width of printing applied in the X direction and causing printing to occur in greater resolution than said native resolution.

47. The printer of claim 46, further comprising one or more elongated ink curing stations residing substantially parallel to the support and substantially spanning the width W2.

48. The printer of claim 46, where the first array substantially spans the width W2.

49. The printer of claim 46, further comprising one or more additional arrays of multiple inkjet print heads mounted to the support at different pivot points distributed along the X direction such that pivoting of the arrays reduces spacing between printing of the ink jets in the X direction to cause printing in greater resolution than a native resolution of the inkjet print heads of the arrays individually.

50. The printer of claim 49, where the first array and the additional arrays are pivotable independently of each other.

51. A printing process utilizing a printer including a conveyor defining an X direction (W) and a Y direction (L) perpendicular to the X direction, the conveyor configured to receive a substrate of maximum width W2 in the X direction and to move the substrate linearly in the Y direction, the printer further including a first array of multiple inkjet print heads distributed along a length of the first array, where the print heads have a prescribed native resolution and a prescribed dot pitch, the process comprising:
providing at least one support spanning the conveyor in the X direction, where the first array is pivotably mounted at its midpoint to the support, where the first array is pivotable about an axis perpendicular to the X and Y directions;
during printing, pivoting the array sufficient to reduce and compress a width of printing applied in the x direction and causing printing to occur in greater resolution than said native resolution.

52. The process of claim 51, further comprising providing one or more elongated ink curing stations residing substantially parallel to the support and substantially spanning the width W2.

53. The process of claim 51, where the first array substantially spans the width W2.

54. The process of claim 51, further comprising:
providing one or more additional arrays of multiple inkjet print heads mounted to the support at different pivot points distributed along the X direction;
pivoting the arrays to reduce spacing between printing of the ink jets in the X direction to cause printing in greater resolution than a native resolution of the inkjet print heads of the arrays individually.

55. The process of claim 54, further comprising pivotably positioning the arrays independent of each other.

56. The process of claim 54, further comprising shifting the arrays in the X direction in order to compensate for one or more defective inkjet nozzles in the arrays.
